(19) United States
(12) Patent Application Publication
(10) Pub. No.: US 2009/0081330 A1
(43) Pub. Date: Mar. 26, 2009

(54) TREATMENT OF SUGARCANE SILAGE WITH BACTERIAL ADDITIVES

(75) Inventors: Limin Kung, JR., Newark, DE (US); Luiz Gustavo Nussio, SaoPaulo (BR); Robert C. Charley, Niagara-on-the-Lake (CA)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Lallemand, USA, Inc., Montreal (CA)

(21) Appl. No.: 11/679,300

(22) Filed: Feb. 27, 2007

Related U.S. Application Data
(60) Provisional application No. 60/778,451, filed on Mar. 2, 2006.

(51) Int. Cl. A23B 9/28; A23K 3/03; A23L 3/3463

(52) U.S. Cl. 426/54; 426/635; 426/532

(57) ABSTRACT

Compositions and methods for treating silage are provided. In one aspect, a method for treating silage includes applying a composition comprising at least Lactobacillus diolivorans to the silage. As a result of the presence of this composition the amount of dry matter recovered is increased and the aerobic stability of the silage is improved.

### CROSS-REFERENCE TO RELATED APPLICATIONS

The pending application claims priority to U.S. Provisional Application Ser. No. 60/778,451, filed Mar. 2, 2006 and entitled “Treatment of Sugarcane Silage with Bacterial Additives,” the disclosure of which is incorporated by reference herein.

### FIELD OF THE INVENTION

The present invention relates to methods and compositions for use in treating silage, in particular, sugarcane.

### BACKGROUND OF THE INVENTION

Silage is fermented, high-moisture forage to be fed to ruminants, such as cud-chewing animals like cattle and sheep. The silage is fermented and stored in a storage silo, a process called ensilage. Silage is most often made from grass crops, including corn (maize) or sorghum. Silage is made from the entire plant, not just the grain. Silage can also be made from many other field crops (including sugar cane), and other names (oatlage for oats, haylage for alfalfa) are sometimes used when this is done. Sometimes a mixture is used, such as oats and peas.

The production of silage and the associated crop husbandry have over recent years developed to an extent that a number of different processes can be defined. These are: (i) the ensiling of young grass with particularly low dry matter, e.g. less than 25%; (ii) the ensiling of higher dry matter, more mature grasses, or the ensiling of high dry matter but young grass achieved by wilting; and (iii) the ensiling of whole maize including stover and cob, usually at a dry matter concentration of about 35%, and whole crop cereals, e.g. wheat, at 45-50% dry matter.

While these processes generally produce a good yield, they are not without their problems. Particularly in cases (ii) and (iii), one major problem occurs on a regular basis. This is the phenomenon known as aerobic spoilage. This phenomenon is not well understood, and while there are many differing opinions, most agree that the process of aerobic spoilage can be divided into specific phases. First, there is an initial phase in which yeasts and sometimes acetic acid bacteria start to respire the preserving organic acids, raising the silage pH, and the temperature begins to rise. After an initial rise in pH, there is a secondary phase in which the activity of bacilli is apparent, and is associated with increasing temperature. A further phase includes activity of various microorganisms including fungi.

In those silages which contain a substantial content of dry matter, i.e. over 30%, the problem of spoilage is particularly acute. Spoilage is seen to a greater or lesser extent once a silage clamp is opened and exposed to air.

Fermative treatment with lactic acid bacteria is a common procedure to prevent spoilage and preserve the high nutritional value of the silage. This procedure is based on lactic acid fermentation of water-soluble carbohydrates by lactic acid bacteria, which are common members of the natural epiphytic microflora of freshly harvested crops. However, even when satisfactory preservation under anoxic conditions has been attained, exposure to air, particularly during feed-out, may result in aerobic growth of yeasts and fungi at the expense of lactic acid. This process is referred to as aerobic spoilage.

While it is not well understood, aerobic spoilage results in dramatic losses in the nutritional value of spoilage. Generally, the process of aerobic spoilage has been divided into three phases. In the initial phase, yeasts and sometimes acetic acid bacteria start to respire the preserving organic acids, raising the silage pH and temperature. After this initial rise in pH, there is a secondary phase in which the activity of bacilli is apparent, and is associated with increasing temperature. A further phase includes activity of various microorganisms including fungi.

Biological additives such as bacterial inoculants have been used widely to improve the silage process, primarily to increase the extent and rate of lactic acid production, and guard against aerobic spoilage. U.S. Pat. No. 6,326,037 to Mann et al. provides methods and compositions for improving this situation. In particular, the invention there described is based at least in part on identifying the aerobic spoilage process as being closely related to heating in the clamp on exposure to the ingress of air. Subsequent examination of such silages showed high concentration of thermophilic Gram-positive bacteria, including bacilli, yeasts and molds. This apparently demonstrates the onset of a secondary fermentation, akin to that of composting (the primary fermentation being the ensiling process). In this fermentation stage, yeast and moulds predominate. It appears that, in order to prevent spoilage, the three main categories of organisms that need to be killed or suppressed are spore-forming bacteria, yeasts and fungi. To eliminate only one category may lead to the proliferation of the remaining categories, so that spoilage is not prevented.

Accordingly, Mann teaches spoilage prevention by using treatment organisms that, at least in the first instance, inhibit microorganisms that initiate aerobic spoilage, notably yeasts and, at the surface of silage, fungi. An organism capable of doing this may also inhibit the development of other spoilage microorganisms, and may be identified by screening. An organism of the species Lactobacillus buchneri, that meets this requirement has been deposited at the National Collection of Industrial and Marine Bacteria on 13 Feb. 1996. Its accession number is 40788.

A further organism has also been found in silage as described in J. Krooneman et al., Lactobacillus diolivorans sp. nov., a 1,2-propanediol-degrading bacterium isolated from aerobically stable maize silage, International Journal of Systematic and Evolutionary Microbiology, Vol 52, pp. 639-646 (2002). There it was noted that inoculation of maize silage with Lactobacillus buchneri (5×10⁵ c.f.u. per gram of maize silage) prior to ensiling results in the formation of aerobically stable silage. After 9 months, lactic acid bacterium counts were approximately 10¹⁰ c.f.u. per gram in the treated silages. An important subpopulation (5.9×10⁷ c.f.u. per gram) proved able to degrade 1,2-propanediol, a fermentation product of L. buchneri, under anoxic conditions to 1-propanol and prop ionic acid. From this group of 1,2-propanediol-fermenting, facultatively anaerobic, heterofermentative lactobacilli, two rod-shaped isolates were purified and characterized. Comparative 16S rDNA sequence analysis revealed that the newly isolated bacteria have identical 16S rDNA sequences and belong phylogenetically to the L. buchneri group. DNA—DNA hybridizations, whole-cell protein fingerprinting and examination of phenotypic properties indicated that these two isolates represent a novel species, for which the name Lactobacillus diolivorans sp. nov. was proposed. The type strain is LMG 19667(T) (=DSM 14421 (T)). The entirety of this article is incorporated herein by reference. Use of this strain to improve the stability of silage that is exposed to air is described in published United States Patent Application Publication No. US-2005-0281917-A1, which is also hereby incorporated by reference.

While treatments using Lactobacillus buchneri reduce spoilage in silage, they do so to only a limited extent. Accordingly, the remains a need for an improved silage treatment, particularly for improving aerobic stability of silage while increasing the amount of dry matter recovered.

### SUMMARY OF THE INVENTION

The present invention provides methods and compositions for treating silage, and in particular, sugarcane. In one aspect, a method for treating silage is provided that includes adding an effective amount of a composition comprising Lactobacillus diolivorans to the silage. The Lactobacillus diolivorans is effective to reduce the dry matter content of the silage.

A variety of Lactobacillus diolivorans compositions can be used with the method disclosed herein. In one embodiment, the composition can include at least about 1×10⁵ cfu/g of Lactobacillus diolivorans. In other embodiments, the composition can include Lactobacillus diolivorans with 1,2-propanodiol, such as 1,2-propanodiol that is produced by Lactobacillus buchneri, and/or Lactobacillus buchneri. In embodiments where the composition also includes 1,2-propanodiol, the composition comprises at least about 1% 1,2-propanodiol and at least about 1×10⁶ cfu/g Lactobacillus diolivorans. In embodiments where the composition also includes Lactobacillus buchneri, the composition comprises at least about 1×10⁶ cfu/g Lactobacillus diolivorans and at least about 5×10⁴ cfu/g of Lactobacillus buchneri.

In use, such a composition results in greater than about 70.9% dry matter recovered after 80 days of fermentation as well as greater than about 70.5% dry matter recovered after 140 days of fermentation. Additionally, the composition is effective to recover at least about 0.5 cfu/g of dry matter when compared with traditional treatment methods.

In another aspect, the application provides a silage inoculant that includes an effective amount of Lactobacillus diolivorans and an effective amount of an additional inoculant. The composition is effective to prevent or reduce spoilage of the silage.

A variety of additional inoculants can be used. In one embodiment, the additional inoculant is 1,2-propanodiol that is produced by Lactobacillus buchneri. By way of non-limiting example, the resulting composition can include at least about 1% 1,2-propanodiol and at least about 1×10⁶ cfu/g Lactobacillus diolivorans. In another embodiment, the additional inoculant is Lactobacillus buchneri, and the resulting composition can include at least about 1×10⁶ cfu/g Lactobacillus diolivorans and at least about 5×10⁴ cfu/g of Lactobacillus buchneri.

In yet another aspect, a silage product is provided that includes a silage and an inoculant composition having an effective amount of Lactobacillus diolivorans and an effective amount of an additional inoculant. While the product can include a variety of silages, in one embodiment the silage can be sugarcane.

### BRIEF DESCRIPTION OF THE DRAWINGS

The invention can be more fully understood from the following detailed description taken in conjunction with the accompanying drawings, in which:

FIG. 1 is a table illustrating the effects of compositions and methods of the invention in dry matter recovery in sugarcane silages after 80 days of fermentation;

FIG. 2 is a table illustrating the effects of compositions and methods of the invention in dry matter recovery in sugarcane silages after 140 days of fermentation;

FIG. 3 is a table illustrating the effects of compositions and methods of the invention in mean values of dry matter content (105° C.) from sugarcane silages;

FIG. 4 is a table illustrating the effects of compositions and methods of the invention in mean values of NDF from sugarcane silages;

FIG. 5 is a table illustrating the effects of compositions and methods of the invention in mean values of ADF from sugarcane silages;

FIG. 6 is a table illustrating the effects of compositions and methods of the invention in mean values of ash from sugarcane silages;

FIG. 7 is a table illustrating the effects of compositions and methods of the invention in mean values of crude protein from sugarcane silages; and

FIG. 8 is a table illustrating the effects of compositions and methods of the invention in time spent to initiate temperature raise in sugarcane silages after air exposure.

### DETAILED DESCRIPTION OF THE INVENTION

Certain exemplary embodiments will now be described to provide an overall understanding of the principles of the structure, function, manufacture, and use of the methods and compositions disclosed herein. Those skilled in the art will understand that the methods and compositions specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

The present invention generally provides methods and compositions for treating silage. In one embodiment, the method includes applying a composition comprising at least Lactobacillus diolivorans to the silage. As a result of the Lactobacillus diolivorans composition, the amount of dry matter recovered is increased and the aerobic stability of the silage improved. The presence of such a composition can also affect the amounts of other chemicals within the silage, as shown in the examples below. One skilled in the art will appreciate that the compositions and methods disclosed herein can be used with a variety of silages, in particular, the use of the compositions and methods described herein provide surprising and unexpected improvements when applied to the ensiling of sugarcane.

Additionally, the compositions and methods can be used to treat silages that include at least 25% by weight dry matter, such as rye or traditional grass, maize, Lucerne, wilted grass, wheat, barley, or other whole crop cereal. The silage can be in bales, or alternatively, any susceptible animal feed (e.g., for pigs, poultry, or ruminants) in a solid or liquid form.

Moreover, the compositions and methods disclosed herein can be used to inhibit the growth of various spoilage organisms (e.g., bacteria, molds, and fungi), such as Listeria organisms, Bacillus spp., Guillermondella selenospora, Trichoderma longibrachiatum, Aspergillus niger, Monascus, Pennicillium roquefortii, Fusarium spp., and enteric bacteria such as Salmonella.

Following methods as discussed below, Applicants discovered chemical and microbial compositions having Lactobacillus diolivorans that are better able to treat and prevent aerobic spoilage in silage, and in particular sugarcane. The Lactobacillus diolivorans can be applied to the silage in a variety of compositions. In one embodiment, the composition can include at least about 1×10⁵ cfu/g Lactobacillus diolivorans.

In other embodiments, the Lactobacillus diolivorans can be used in combination with either Lactobacillus buchneri or 1,2-propanodiol. Exemplary forms of 1,2-propanodiol can include synthetic 1,2-propanodiol as well as 1,2-propanodiol that is produced by Lactobacillus buchneri. By way of non-limiting example, one composition can include at least 1% 1,2-propanodiol and at least about 1×10⁶ cfu/g Lactobacillus diolivorans. Another composition can include at least about 1×10⁶ cfu/g Lactobacillus diolivorans and at least about 5×10⁴ cfu/g of Lactobacillus buchneri. Exemplary compositions are noted in the example below.

The results of these compositions when applied to silage are shown in the example below.

### EXAMPLE

This example was designed to study the effect of two microbial additives (L. buchneri and L. diolivorans), urea, and 1,2-propanodiol in fermentative profile and chemical composition of sugarcane silages. L. buchneri and L. diolivorans, combined or exclusively, urea (1% wet basis) 1,2-propanodiol (1% dry matter basis) combined with L. diolivorans or exclusively, were used as silage treatments.

Experimental units were formed using sugarcane silage and the following treatments, at least some of which contained Lactobacillus diolivorans:

| Treatment Designation | Treatment |
|---|---|
| Control | Water |
| LB | Lactobacillus buchneri 5× 10⁴ cfu/g |
| LD (10⁵) | Lactobacillus diolivorans 1× 10⁵ cfu/g |
| LD (10⁶) | Lactobacillus diolivorans 1× 10⁶ cfu/g |
| LB + LD | Lactobacillus buchneri 5× 10⁴ cfu/g + |
| | Lactobacillus diolivorans 1× 10⁶ cfu/g |
| Urea (1%) | |
| 1,2 Prop | l,2-propanodiol (1%) |
| 1,2-Prop + LD | 1,2-Propanodiol (1%) + Lactobacillus |
| | diolivorans 1× 10⁶ cfu/g |

Once formed, the units were placed in buckets (20 L) provided with a Bunsen type valve to allow escape of gases, and dried sand to drain effluent production.

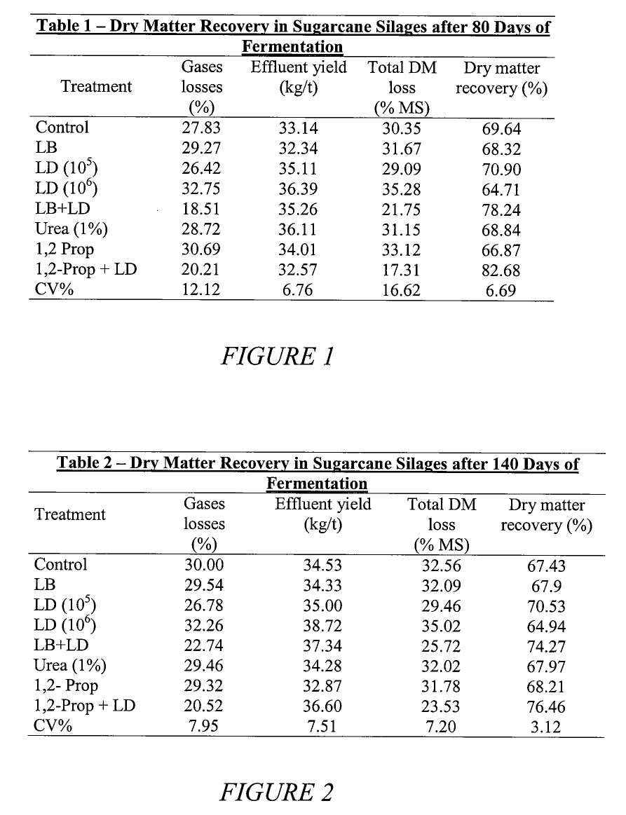

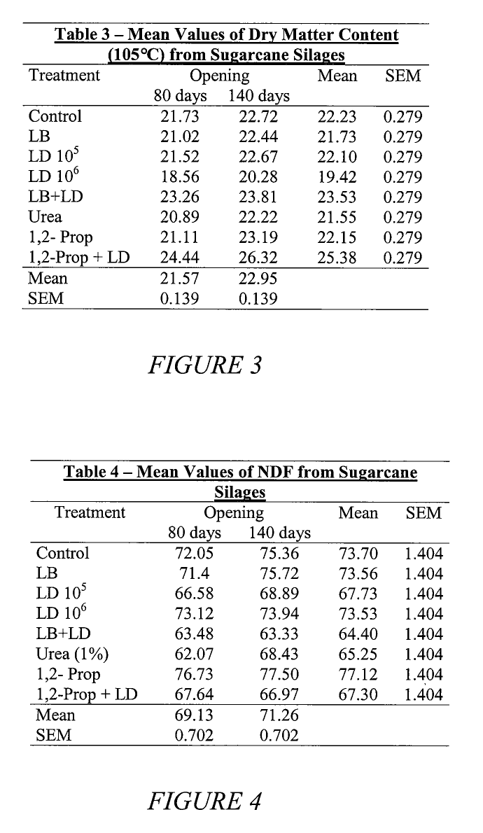

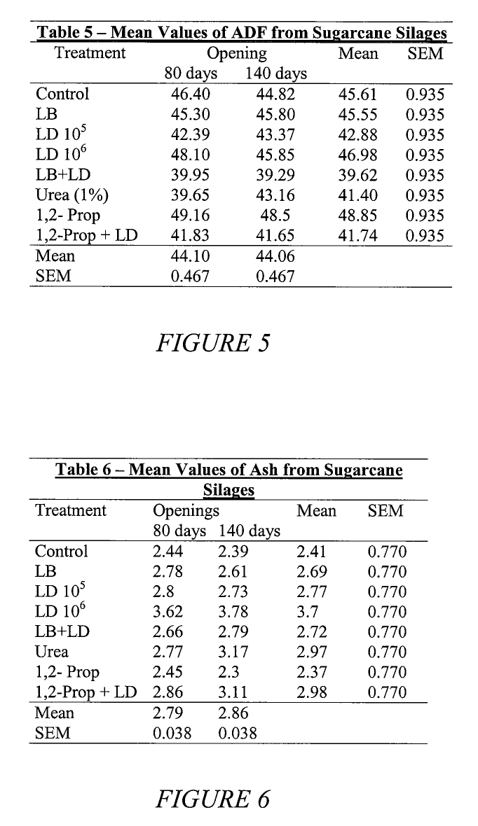

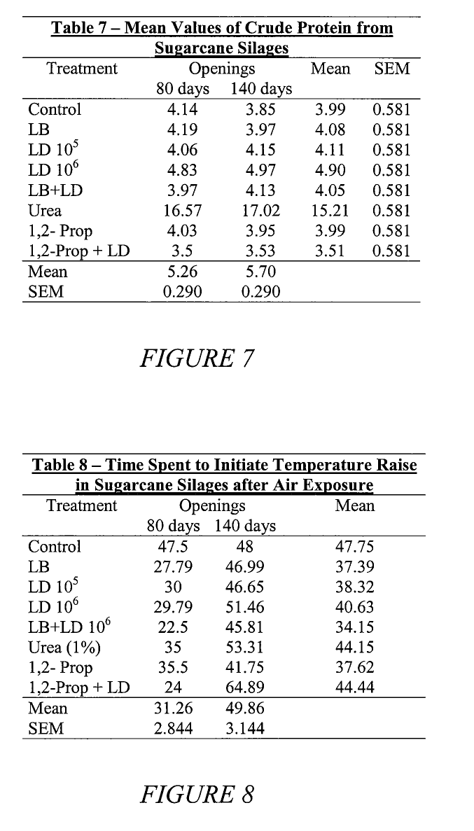

The trial was performed according to a completely randomized design, with 8 treatments, 2 periods of fermentation (80 and 140 days) and 4 replications each treatment. Samples were taken to analyze dry matter (based on weight disappearance), as well as the presence of chemicals such as crude protein (CP), Neutral Detergent Fiber (NDF), Acid Detergent Fiber (ADF), and ash. Additionally, after silo openings (80 or 140 days), temperature data was taken to measure the aerobic stability of silages. These results are shown in Tables 1-8 (provided in FIGS. 1 to 8, respectively). All mean results have the potential to vary by P<0.05.

As can be seen most particularly in Tables 1 and 2 (FIGS. 1 and 2, respectively), while some LD formulations alone can improve the recovery of dry matter for sugarcane silage after 80 and 140 days when compared to a control, LB alone, urea, and 1,2 Prop alone, the formulations of LB+LD and 1,2 Prop+LD show significantly higher dry matter recovery. This surprising result could not be predicted from previous work applying LB or LD as none suggest the improvement of dry matter recovery—or, put another way, the improved inhibition of dry matter loss, in particular, in sugarcane silage.

While not wishing to limit the invention to one mechanism of operation, Applicants observed that compositions that include Lactobacillus diolivorans as well as a source of 1,2-propanodiol, produced by Lactobacillus buchneri or 1,2-propanodiol synthetic, showed the most positive results in dry matter recovery and gases losses. The best result performed by Lactobacillus diolivorans plus 1,2-propanodiol achieved 82.68% and 76.46% of dry matter recovery rate after 80 and 140 days of storage, respectively, compared with the control treatment (69.64% and 67.43%). Additionally, higher dry matter recovery rates were obtained when Lactobacillus diolivorans was inoculated combined with Lactobacillus buchneri (78.24% and 74.27% after 80 and 140 days).

Applicants also note that at 140 days, the treatment containing Lactobacillus diolivorans 10⁵ cfu/g showed lower DM total loss when compared with Lactobacillus diolivorans 10⁶ cfu/g. It might be explained by the low concentration of 1,2-propanodiol frequently find in control silages which could lead to a more intensive substrate competition at 10⁶ cfu/g for Lactobacillus diolivorans.

Treatments with bacteria inoculated exclusively (LB, LD 10⁵, LD 10⁶) or chemical (urea e 1,2-propanodiol) did not result in significant improvement in dry matter recovery rate when compared with the control. However, the treatments containing Lactobacillus diolivorans added with a source of propanodiol were better than the control for DM recovery rate.

Additionally, treatments with Lactobacillus diolivorans added with a source of 1,2-propanodiol showed the lowest value for FDN. This is probably due to the higher concentration of soluble carbohydrates remained after fermentation, and the difference observed between the two opening periods may be explained by the depletion of carbohydrates during the extra period.

The intensive utilization of soluble carbohydrates during fermentation might also explain the trend of increasing (not significant) in aerobic stability at 140 days, when compared with 80 days. The mean values of ADF from silages were lower for Lactobacillus diolivorans plus a source of 1,2-propanodiol (39.62% and 41.74%), urea (41.40%), and Lactobacillus diolivorans 10⁵ cfu/g (42.88%) when compared with control (45.61%). Crude protein content was higher in treatment with urea; this is expected because the increase of nitrogen (not protein source).

A person of ordinary skill in the art will appreciate further features and advantages of the invention based on the above-described embodiments. For example, specific features from any of the embodiments described above as well as in U.S. Pat. No. 6,326,037 to Mann may be incorporated into compositions or methods of the invention in a variety of combinations and sub-combinations, as well as features referred to in the claims below which may be implemented by means described herein. Accordingly, the invention is not to be limited by what has been particularly shown and described, except as indicated by the appended claims or those ultimately provided. Any publications and references cited herein are expressly incorporated herein by reference in their entirety.

What is claimed is:

1. A method for treating silage, comprising:
adding an effective amount of a composition comprising Lactobacillus diolivorans to a silage,
the composition being effective to inhibit dry matter loss in the silage.

2. The method of claim 1, wherein the composition comprises at least about 1×10⁵ cfu/g of Lactobacillus diolivorans.

3. The method of claim 1, wherein the composition comprises Lactobacillus diolivorans and 1,2-propanodiol.

4. The method of claim 3, wherein the composition comprises at least about 1% 1,2-propanodiol and at least about 1×10⁶ cfu/g Lactobacillus diolivorans.

5. The method of claim 3, wherein the 1,2-propanodiol is produced by Lactobacillus buchneri.

6. The method of claim 1, wherein the composition comprises Lactobacillus diolivorans and Lactobacillus buchneri.

7. The method of claim 6, wherein the composition comprises at least about 1×10⁶ cfu/g Lactobacillus diolivorans and at least about 5×10⁴ cfu/g of Lactobacillus buchneri.

8. The method of claim 1, wherein greater than about 70.9% dry matter is recovered after 80 days of fermentation.

9. The method of claim 1, wherein greater than about 70.5% dry matter is recovered after 140 days of fermentation.

10. The method of claim 1, wherein the composition is effective to recover at least about 0.5 cfu/g of dry matter when compared with traditional treatment methods.

11. The method of claim 1, wherein the silage is a sugarcane silage.

12. The method of claim 1, wherein the Lactobacillus diolivorans composition is effective to improve the aerobic stability of the silage.

13. A silage inoculant, comprising:
an effective amount of Lactobacillus diolivorans; and
an additional inoculant;
wherein the composition is effective to prevent or reduce spoilage of the silage.

14. The composition of claim 13, wherein the additional inoculant is 1,2-propanodiol.

15. The composition of claim 14, wherein the 1,2-propanodiol is produced by Lactobacillus buchneri.

16. The composition of claim 14, wherein the composition includes at least about 1% 1,2-propanodiol and at least about 1×10⁶ cfu/g Lactobacillus diolivorans.

17. The composition of claim 13, wherein the additional inoculant is Lactobacillus buchneri.

18. The composition of claim 17, wherein the composition includes at least about 1×10⁶ cfu/g Lactobacillus diolivorans and at least about 5×10⁴ cfu/g of Lactobacillus buchneri.

19. The composition of claim 13, wherein the silage is a sugarcane silage.

20. A silage product, comprising:
a silage; and
an inoculant composition comprising an effective amount of Lactobacillus diolivorans and an additional inoculant.

21. The silage product of claim 20, wherein the silage is a sugarcane silage.

22. The silage product of claim 20, wherein the additional inoculant is Lactobacillus buchneri.

23. The silage product of claim 20, wherein the additional inoculant is 1,2-propanidiol.

24. The silage product of claim 20, wherein the inoculant composition comprises at least about 1×10⁶ cfu/g Lactobacillus diolivorans and at least about 5×10⁴ cfu/g of Lactobacillus buchneri.

25. The silage product of claim 20, wherein the inoculant composition comprises at least about 1% 1,2-propanodiol and at least about 1×10⁶ cfu/g Lactobacillus diolivorans.
